(19) United States
(12) Patent Application Publication
(10) Pub. No.: US 2004/0221881 A1
(43) Pub. Date: Nov. 11, 2004

(54) Sprayer and kit including a sprayer

(75) Inventors: John Allen Wooton, New Richmond, OH (US); Kenneth Norman Kern, Loveland, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/776,854

(22) Filed: Feb. 11, 2004

Related U.S. Application Data
(63) Continuation-in-part of application No. 10/022,027, filed on Dec. 13, 2001.
(63) Continuation-in-part of application No. 10/137,748, filed on May 2, 2002.
(63) Continuation-in-part of application No. 10/713,460, filed on Nov. 14, 2003.

(51) Int. Cl. B08B 3/02

(52) U.S. Cl. 134/123; 134/172; 134/201; 134/198

(57) ABSTRACT

A sprayer and a kit including a sprayer and accessories for use with the sprayer is disclosed. In one non-limiting embodiment, the kit may include a carrying case for the sprayer and accessories for the sprayer. The carrying case may have a number of features. Since the sprayer and accessories may be wet after use, the carrying case may have one or more openings therein that provide vents to facilitate drying of the sprayer and accessories after they are used and placed in the carrying case. The carrying case may include one or more of the following items in addition to the sprayer: a purifier for the sprayer; soap for use with the sprayer; quick-connect adaptors to facilitate connecting the sprayer to a water hose, such as a garden hose; and one or more devices for use in a washing process. If the kit is for car care, such one or more devices may include, but are not limited to: a washing implement such as a brush, a cloth, or a wash mitt.

### CROSS REFERENCE TO RELATED APPLICATIONS

This application is a continuation-in-part of the following U.S. Patent applications: U.S. patent application Ser. No. 10/022,027 filed on Dec. 13, 2001; and U.S. patent application Ser. No. 10/137,748 filed on May 2, 2002; U.S. patent application Ser. No. 10/713,460 filed on Nov. 14, 2003.

### FIELD OF THE INVENTION

The present invention relates to a sprayer and a kit including a sprayer and accessories for use with the sprayer.

### BACKGROUND OF THE INVENTION

Sprayers of various types are known. In some cases, sprayers have a filter or other type of purifier associated therewith. The search for improved sprayers and kits including such sprayers as well as accessories for use with the sprayers has continued.

### SUMMARY OF THE INVENTION

This invention relates to a sprayer and a kit including a sprayer and accessories for use with the sprayer. There are numerous non-limiting embodiments of the present invention.

In one non-limiting embodiment, the sprayer is for spraying water and, when in use, comprises a purifier cartridge for purifying water. Such a sprayer can be used for washing various surfaces, including but not limited to exterior vehicle surfaces. The sprayer may be compact and ergonomic. The sprayer may have a handle with a soft ergonomic grip. The sprayer may comprise a valve system that provides a selection of water flow paths and/or nozzles or other output mechanisms for the sprayer, and a selector switch for controlling the valve system. The selector switch may also have soft ergonomic portions thereon. The valve system of sprayer, in one embodiment, is capable of facilitating the user's compliance with a defined wash and rinse process comprising at least a washing step, a shower rinse setting, a high pressure or power rinse setting, and a purified rinse step.

The sprayer may be provided as part of a kit. In one non-limiting embodiment, the kit may comprise a carrying case for the sprayer and accessories for the sprayer. The carrying case may have a number of features. Since the sprayer and accessories may be wet after use, the carrying case may have one or more openings therein that provide vents to facilitate drying of the sprayer and accessories after they are used and placed in the carrying case.

The carrying case may include one or more of the following items in addition to the sprayer: a purifier for the sprayer; soap for use with the sprayer; quick-connect adaptors to facilitate connecting the sprayer to a water hose, such as a garden hose; and one or more devices for use in a washing process. If the kit is for car care, such one or more devices may include, but are not limited to: a washing implement such as a brush, a cloth, or a wash mitt.

Numerous other embodiments are also possible, including, but not limited to those described in the following detailed description.

The present invention will become more readily apparent when considered in reference to the following description and when taken in conjunction with the accompanying drawings.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings, in which:

FIG. 1 is a front view of one non-limiting embodiment of a kit comprising a carrying case that includes a sprayer and accessories for use with the sprayer.

FIG. 2 is a front view of the components of the kit shown removed from the carrying case.

### DETAILED DESCRIPTION OF THE INVENTION

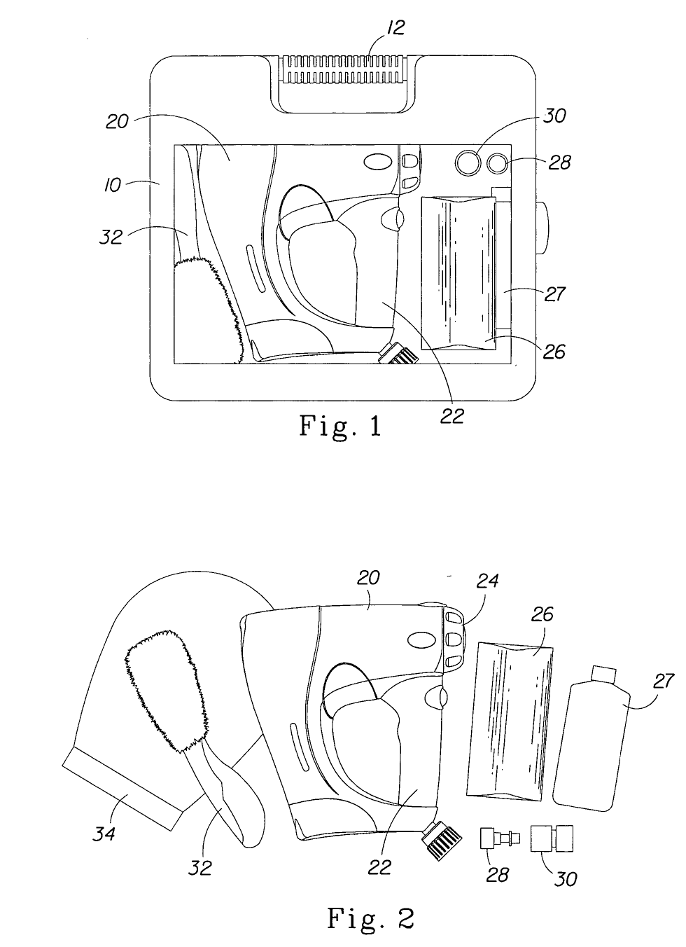

The present invention relates to a sprayer and a kit including a sprayer and accessories for use with the sprayer. FIG. 1 shows one non-limiting embodiment of a kit comprising a carrying case 10 that includes a sprayer 20 and accessories for use with the sprayer.

The carrying case 10 may have a number of features. The carrying case 10 has a top, a bottom, a front side, a rear side, and ends. The carrying case 10 may also have a handle 12. The carrying case 10 may have one or more openings therein, on any portion of the surface of the carrying case 10. For example, the front of the carrying case may have one or more openings therein to display the components in the carrying case 10.

Since the sprayer and accessories may be wet after use, the carrying case 10 may have other openings to provide vents to facilitate drying of the sprayer 20 and accessories after they are used and placed in the carrying case 10. Alternatively, the opening in the front of the carrying case 10 may be used for this purpose. Any of these openings can either be left uncovered, or they can be covered with some suitable material, such as a mesh, or other air permeable material. The carrying case 10 may also have drain holes in the bottom thereof to drain water out of the carrying case 10.

The carrying case 10 can be made of any suitable material. In certain embodiments, it is desirable for the carrying case 10 to be durable. For instance, it may be desirable for the carrying case 10 to be made of some material other than cardboard. In one non-limiting embodiment, the carrying case 10 is made of plastic.

In the embodiment shown, the sprayer 20 is for spraying water and, when in use, comprises a purifier cartridge for purifying water. The sprayer 20 shown in the drawings has a unique configuration. It should be understood that the sprayer 20 can be provided in any suitable configuration, and that the present invention is not limited to sprayers (or accessories) having the configuration shown in the drawings.

Such a sprayer can be used for washing various surfaces, including but not limited to exterior vehicle surfaces. The sprayer may be compact and ergonomic. Non-limiting embodiments of sprayers suitable for inclusion in the kit are described in U.S. patent application Ser. No. 09/950,841 filed on Sep. 11, 2001 published in the name of Horstman, et al. as U.S. patent application Publication No. 2002/0185420 A1 on Dec. 12, 2002; U.S. patent application Ser. No. 10/713,460 filed on Nov. 14, 2003; and U.S. Design Patent Application Serial No. 29/193,107 filed on Nov. 3, 2003. The sprayer 20 may have a handle with a soft ergonomic grip 22. The soft ergonomic grip 22 may be a material (e.g., a rubberized material) that is molded on the handle of the sprayer, or it may comprise a sprayed-on soft touch paint.

The sprayer 20 may comprise a valve system that provides a selection of water flow paths and/or nozzles or other output mechanisms for the sprayer, and a selector switch 24 for controlling the valve system. The selector switch 24 may also have soft ergonomic portions thereon. The valve system can have any suitable number of liquid conduits or spray paths. The valve system of sprayer, in one embodiment, has four liquid conduits, and is capable of facilitating the user's compliance with a defined wash and rinse process comprising at least a washing step, a shower rinse setting, a high pressure or power rinse setting, and a purified rinse step.

The sprayer 20 can be manufactured in any suitable manner. The housing and many other components of the sprayer 20 can be made of any suitable material, such as plastic. In the embodiment shown, the housing can be comprised of two, or more pieces. The components of the sprayer 20 can be assembled inside of at least one of the pieces comprising the housing, and the pieces of the housing can then be secured together.

The carrying case 10 may include one or more of the following items in addition to the sprayer: a purifier 26 for the sprayer; a cleaning composition 27, such as soap for use with the sprayer; quick-connect adaptors 28 and 30 to facilitate connecting the sprayer to a water hose, such as a garden hose; and one or more devices for use in a washing process. If the kit is for car care, such one or more devices may include, but are not limited to: a washing implement such as a brush 32, a cloth, or a wash mitt 34.

In the embodiment shown in the drawings, the purifier 26 comprises a purifier cartridge. The purifier cartridge 26 can be in any suitable configuration provided that it works with the sprayer 20. The purifier cartridge 26 can be permanent or replaceable. The purifier cartridge 26 can comprise any suitable type of purifying material. In one non-limiting embodiment, the purifier cartridge 26 comprises an ion exchange resin medium. The ion exchange resin medium may have any of the properties described in U.S. Pat. No. 6,562,142 B2 issued to Barger, et al.

The cleaning composition can comprise any suitable cleaning composition. In one embodiment, the cleaning composition comprises a polymer that renders the surface of the vehicle hydrophilic. One suitable polymer is described in U.S. Pat. No. 6,593,288 B2 issued to Aubay, et al. on Jul. 15, 2003. A suitable cleaning composition is described in U.S. patent application Publication No. U.S. 2002/01600224 A1, published in the name of Barger, et al. on Oct. 31, 2002.

The quick-connect adaptors 28 and 30 include male adaptor 28 and female adaptor 30. The female adaptor 30 is of the type that can be screwed onto the threaded connector at the end of a garden hose. The male adaptor 28 can be connected to the hose connection that extends outward at the bottom of the sprayer 20. Once the male and female adaptors are connected to these respective connections, the male adaptor 28 provides a projecting element that fits into a recess in the female adaptor 30 that provides a non-threaded connection of the sprayer 20 to a garden hose.

The disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

While particular embodiments of the subject invention have been described, it will be obvious to those skilled in the art that various changes and modifications of the subject invention can be made without departing from the spirit and scope of the invention. In addition, while the present invention has been described in connection with certain specific embodiments thereof, it is to be understood that this is by way of illustration and not by way of limitation and the scope of the invention is defined by the appended claims which should be construed as broadly as the prior art will permit.

What is claimed is:

1. A kit for cleaning and treating an exterior surface of a vehicle, said kit comprising:
a carrying case, said carrying case being durable and containing:
a spraying device for connection to the end of a hose;
a cleaning composition; and
at least one adaptor for providing a non-threaded connection of the device to a garden hose.

2. The kit of claim 1 further comprising a purifier for said spraying device.

3. The kit of claim 1 further comprising one or more of the following: a wash mitt and a brush.

4. The kit of claim 1 wherein said carrying case is made of plastic.

5. The kit of claim 4 wherein said carrying case is ventilated.
